(19) United States
(12) Patent Application Publication
(10) Pub. No.: US 2002/0039612 A1
(43) Pub. Date: Apr. 4, 2002

(54) Frozen filled waffle

(76) Inventors: Charles Gambino, Kalamazoo, MI (US); Mark King, Battle Creek, MI (US); Mike Bauman, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/934,394

(22) Filed: Aug. 21, 2001

Related U.S. Application Data
(60) Provisional application No. 60/227,059, filed on Aug. 21, 2000.

(51) Int. Cl. A21D 13/00

(52) U.S. Cl. 426/283; 426/94

(57) ABSTRACT

A baked toastable freezer stable filled waffle is disclosed. The filled waffle has a batter-based outer casing material that surrounds an inner filling material. Utilization of a filling material having a water content and water activity level below that of the outer casing material enables the formation of a toastable freezer stable filled waffle. The filled waffle can be stored frozen and reheated rapidly in a conventional toaster without burning or charring of the outer casing material and complete heating of the inner filling material.

### RELATED APPLICATIONS

This application claims the benefit of U.S. Provisional Application No. 60/227,059, filed Aug. 21, 2000.

### BACKGROUND OF THE INVENTION

The subject invention relates generally to an improved filled food product and, more specifically, to a frozen toastable filled waffle that is pre-cooked, packaged, and frozen for storage.

Frozen toaster products, such as toaster waffles, have become widely consumed as part of a meal due to their convenience and short preparation time. The typical toaster waffle is pre-cooked, packaged, and frozen for storage. A consumer typically toasts the waffle while it is still frozen. It is desirable to enhance the flavor of the toaster waffle by adding a filling material such as fruit, jelly, cheese, and the like. However, such a product can present several difficulties that may result in reduced quality of the toastable frozen filled waffle.

A typical frozen waffle is produced by depositing waffle batter into a bottom section of a waffle iron, closing the iron, and cooking the batter into a crisp waffle product. The waffle is subsequently frozen and packaged for storage and delivery to consumers. The introduction of a filling material into a waffle requires that a first layer of batter be deposited into the bottom section of the iron followed by a layer of filling material and then a second layer of batter.

A problem with other frozen filled food products is that the filling contains water and once the product is frozen a large portion of the water in the filling is in the crystalline frozen state. These products are typically reheated from the frozen state in an upright toaster. These toasters heat largely in the infrared range by radiant heat. One problem with past filled products is that the water ice crystals act as a heat sink absorbing large amounts of heat to overcome the heat of fusion to thereby convert the water from the solid state to the liquid state when the frozen filled food product is subsequently toasted. The large amount of ice crystals absorb a substantial amount of BTU's of the applied heat with the result that the filling does not heat up to a significant extent during initial heating. As a result, to heat the filling material after ice crystals have formed requires additional heat be radiated through the casing material and into the filing material after the heat of fusion has been reached, which has resulted in burning or charring of the outer casing material in past products. It is unacceptable for consumers if a toastable filled waffle has a cold or icy filling. This problem needs to be overcome for a successful frozen filled waffle.

A related problem for past frozen filled food products is the migration of water from the filling material into the surrounding casing material. Free water molecules having absorbed pigments from, for example, the fruit flavoring in the filling material can migrate into the casing material causing discoloration. Further, the casing material can become soggy and the filling material can lose its flavoring due to migration of water from the filling into the casing material. In fact, the entirety of the filling material has been known to be absorbed into the casing material in other frozen filled food products.

One other potential problem with a filled waffle is the storage stability of the filled waffle. To provide a high level of flavoring and other qualities such as mouth feel, the outer casing of the filled waffle generally needs to be formulated with a high water content. High water content is known to cause the problems noted above in other filled food products.

Therefore, it would be desirable to develop a toastable frozen filled waffle that reheated in a toaster to produce a crisp waffle with a warm filling and no burning of the outer casing material. Furthermore it would desirable to have a filling material that prevents the migration of water from the filling material into the outer casing material. Still further, it would be desirable to produce a frozen filled waffle that retains the filling material in its entirety within the outer casing material.

### SUMMARY OF THE INVENTION

In one embodiment, the present invention is a baked and freezer stable filled waffle comprising an outer casing material formed from a batter comprising a homogeneous mixture of from 30 to 65 percent by weight water, from 25 to 70 percent by weight flour, from 0.05 to 2.5 percent by weight bicarbonate and from 0.04 to 2 percent by weight leavening acid. The outer casing material surrounds a filling material having a positive water content of up to 40 percent by weight with the water content in the filling material being less than the percent by weight water in the outer casing material. The outer casing material has a water activity level of from 0.9 to 0.99 and the filling material has a water activity level of less than or equal to 0.95 with the water activity level of the filling material being less than the water activity level of the outer casing material.

In another embodiment, the present invention is a baked freezer stable filled waffle comprising an outer casing material formed from a batter comprising a homogeneous mixture of from 30 to 65 percent by weight water, from 25 to 70 percent by weight flour, from 0.05 to 2.5 percent by weight bicarbonate and from 0.04 to 2 percent by weight leavening acid. The outer casing material surrounds a filling material formed from a homogeneous mixture comprising a positive water content of up to 40 percent by weight, from 35 to 80 percent by weight sweeteners, and from 0.5 to 50 percent by weight fruit source, with the water content in the filling material being less than the percent by weight water in the outer casing material. The outer casing material has a water activity level of from 0.9 to 0.99 and the filling material has a water activity level of less than or equal to 0.95 with the water activity level of the filling material being less than the water activity level of the outer casing material.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a partial cross-sectional perspective view of a round frozen filled waffle according to the present invention showing the filling material;

FIG. 2 is a partial cross-sectional perspective view of a square frozen filled waffle according to the present invention.

### DETAILED DESCRIPTION OF THE PREFERRED EMBODIMENT

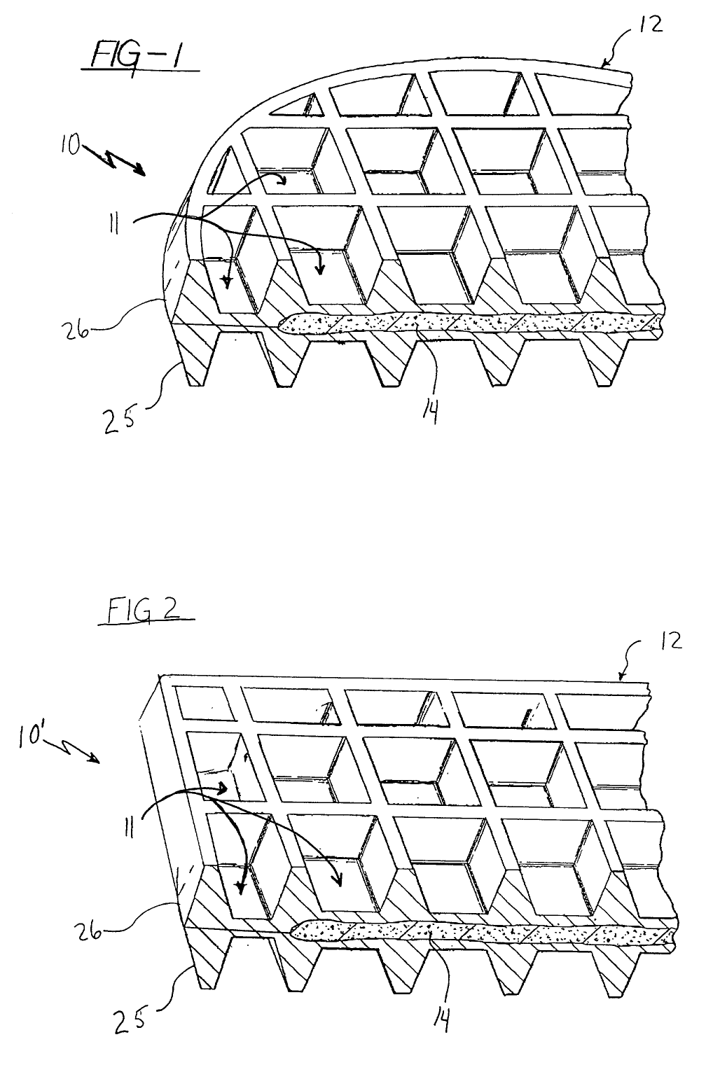

One embodiment of a frozen filled waffle according to the present invention is generally shown at 10 in FIG. 1. In this embodiment, the waffle 10 is shown as a freezer stable, ready to toast batter-based filled waffle having a round perimeter. FIG. 2 shows an alternative embodiment of the waffle 10′ as having a square perimeter. Other polygonal shapes of the perimeter may also be used including rectangular. The waffle 10 can be removed from the freezer and heated in a toaster for consumption. The waffle 10 includes an outer casing material 12 formed from a batter having a moisture content of from about 30 to 65% by weight. A filling material 14 having a moisture content of from about 5 to 40% by weight is disposed inside the outer casing material 12. In all embodiments, the moisture content of the filling material 14 is always lower than that of the outer casing material 12. The waffle 10 includes the usually configuration of webbing 11, the thinnest portions of the waffle, produced by a waffle iron. The aforementioned water content of the waffle 10 is desirable because the consumer perceives the moisture as part of the initial flavor and as part of a pleasing mouth texture.

The filled waffle 10 of the present invention provides the ability to include a high moisture content in the casing material 12 and filling material 14 without adversely affecting the taste and texture due to water migration between the two materials. To manage the migration of water between the casing material 12 and the filling material 14 during cooking and storage, the casing material 12 is formulated to have a higher water activity level than the filling material 14. Preferably, the water activity level for the filling material 14 ranges from about 0.70 to 0.95, especially when no antimicrobial steps or treatments are used in the formulation. More preferably, the water activity of the filling material 14 ranges from about 0.80 to 0.90. The water activity level of the outer casing material 12 will range from about 0.90 and 0.99. The filling material 14 acts as a moisture sink when formulated to have a water activity less than that of the casing material 12. Therefore, free water in the casing material 12 will migrate to the filling material 14. This reduces the potential for water migration from the filling material 14 to the casing material 12, which would result in discoloration and moistening of the casing material 12 and a loss of the quantity and quality of the filling 14.

Antimicrobial steps include, for example, cold temperature storage, heat sterilization, aseptic packaging, chemical preservatives, or combinations of these steps. In another embodiment, one or more of these antimicrobial steps are utilized and this allows the water activity level of the casing material 12 to range from 0.92 to 0.99 and the water activity level of the filling material 14 to range from 0.6 to 0.95.

The casing material 12 must have suitable structural characteristics to resist breaking and/or distorting during manufacturing, packaging, shipping, and final toasting during consumer use. The casing material 12 must support the filling material 14 as the filled waffle 10 sits on its edge when it is heated in the toaster. The casing material 12 must also be strong enough to support itself while being held at an edge during extraction from the toaster.

When preparing the filled waffle 10, a first layer 25 of outer casing material 12 is formed by pouring the batter onto a cooking surface. The first layer 25 rapidly begins to cook. The filling material 14 is then deposited centrally onto the first layer 25 and a second layer 26 of casing material 12 batter is poured over the filling material 14 concealing the filling material 14 between the first and second layers 25, 26. It is important that the filling material 14 not be placed too close to the edges of the layers 25 and 26 or the filling material 14 could leak out on to the baking surface causing burning and production difficulties. A typical waffle has webbing 11 with a thickness of from 0.06 to 0.18 inches. To accommodate the filling material 14, it is necessary to increase the thickness of the webbing 11 in the region of the filling material 14 to about from 0.1 to 0.3 inches. The filled waffle 10 is generally cooked at a temperature ranging from 120° C. to 250° C. The cooking cycle generally ranges from 50 seconds to 240 seconds depending upon the chosen cooking temperature. The waffle grid formed into the first and second layers 25, 26 by the webbing 11 shown in FIGS. 1 and 2 is important for several reasons. First, the grid adds strength to the structure so it will sit upright in a toaster. Second, the grid allows for good penetration of heat to the filling material 14, especially in the places where the waffle 10 is the thinnest.

The on edge height of the waffle 10 according to the present invention must exceed 9.0 cm to enable the consumer to grab an edge of the waffle 10 for extraction from a typical toaster. However, the height of the waffle 10 must not exceed 15.0 cm or it will be too large to fully fit into most upright toasters. The thickness of the waffle 10 can range from about 1.2 cm to roughly 2.0 cm. If the weight of the waffle 10 significantly exceeds 60 grams the spring mechanism on a standard upright consumer toaster will not be able to eject the waffle 10 resulting in a charred or burned waffle 10. Structural integrity of the casing material 12 is derived from the multiple layers and the dimensional design, such as, for example, the waffle ribbing. However, other methods well known in the art of toaster products can be utilized to derive structural integrity.

The filling material 14 may comprise any of a large variety of fillings and flavors. In a first category the filling material may be a sweet filling comprising a fruit based filling, a cream cheese based filling, a sweet flavored filling, or mixtures of these. The fruit based filling may be any fruit such as apple, strawberry, blueberry, grape, apricot, etc. The fruit based filling can also be a jelly or jam type material in combination with peanut butter. Alternatively, the filling material 14 may be peanut butter alone. Any variety of plain or flavored cream cheese may be used, especially fruit and cream cheese mixtures. The filling material 14 may also comprise a sweet flavored filling such as, for example, honey, chocolate flavor, vanilla, vanilla cream, butter, maple, cinnamon, brown sugar, mixtures of these and any other sweet flavored filling. These flavors may be used in combination with the other sweet flavors above. In a second category the filling material 14 can comprise a savory type filling such as a cheese, tomato, tomato and herbs, tomato sauce, vegetables, cheese and vegetable combinations, bacon, ham, pork sausage, beef sausage, meat analogs, and mixtures of these.

Shown in Table 1 is a typical formulation range for the components of the filling material 14, reported as percent by weight based on the total weight of the filling material 14, deposited between the layers 25, 26 of a waffle when the filling material 14 is a fruit based filling:

TABLE 1

| Filling Material | Percent by Weight |
|---|---|
| Water | 0-40% |
| Sweeteners | 35-80% |
| Fruit Source | 0.5-50% |
| Starch | 0-8% |
| Fat | 0-8% |
| Natural and Artificial Flavors | 0-2% |
| Emulsifier | 0-2% |
| Acidulants | 0-2% |
| Hydrocolloid Gum | 0-4% |
| Salt | 0-2% |
| Coloring | 0-2% |
| Antimycotic Preservatives | 0-1% |
| Humectants | 0-20% |
| Fortificants | 0-5% |
| Protein | 0-10% |

The sweeteners preferably are chosen from, but are not limited to, sucrose, dextrose, fructose, lactose, malt syrup, malt syrup solids, rice syrup solids, rice syrup, invert sugar, refiners syrup, corn syrup, corn syrup solids, maltose, high fructose corn syrup, honey, glycerrhizin, arabinose, galactose, glucose, mannitol, maple syrup, ribose, saccharin, xylose, molasses, artificial sweeteners or mixtures thereof. These sweeteners come in many forms including liquid and dry forms. One of ordinary skill in the art would chose the most appropriate form, dry being used to further reduce the water activity of the material and improve other key attributes.

The fruit source is preferably chosen from, but is not limited to, fruit flakes, dry fruit flakes, fruit puree, puree concentrate, juice, juice concentrate, fresh fruit, frozen fruit, fruit concentrate, or mixtures thereof.

The starch preferably is chosen from, but is not limited to, natural or modified starches, cornstarch, waxy cornstarch, rice starch, wheat starch, tapioca starch, potato starch, arrowroot starch, maize starch, oat starch, and mixtures thereof. As would be understood by one of ordinary skill in the art, the term modified starch as used in the present specification and claims is intended to mean chemically modified starches, cold water swelling starches, and pregelatinized starches regardless of the starch source. These modified starches can be beneficial in increasing freezer stability or other processing requirements.

The fat is chosen from, but is not limited to, non-hydrogenated vegetable oil, non-hydrogenated shortening, partially hydrogenated vegetable oil, partially hydrogenated shortening, fully hydrogenated vegetable oil, fully hydrogenated shortening, soybean oil, cottonseed oil, canola oil, peanut oil, safflower oil, sunflower oil, coconut oil, palm oil, palm kernel oil, olive oil, butterfat oil, cocoa butter oil, tallow, lard, corn oil, or mixtures thereof.

The natural and artificial flavors preferably are chosen from, but are not limited to, natural fruit, artificial fruit, fruit concentrate, honey, cinnamon, cocoa, caramel powder, maple syrup, spices, herbs, chocolate flavor, vanilla, vanilla cream, or mixtures thereof.

The emulsifier preferably is chosen from, but is not limited to the following emulsifiers, glycerol esters, diacetyl tartaric acids, esters of monoglycerides, mono and di-glycerides, polyglycerol esters, polysorbate, propylene glycol esters, rice extract esters, sodium stearoyl-2-lactylate, sorbitan esters, lecithins, sugar esters, acetylated monoglycerides, or mixtures thereof.

The acidulants preferably are chosen from, but not limited to, citric acid, malic acid, tartaric acid, lactic acid, acetic acid, phosphoric acid, adipic acid, glucono delta lactone acid, fumaric acid, succinic acid, tarenic acid, or mixtures thereof.

The hydrocolloid gum preferably is chosen from, but is not limited to, pectin, guar, locust bean, tara, gellan, alginate, tragacanth, karaya, Ghatti, agar, gelatin, arabic, acacia, carrageenan, xantham, cellulose, carboxymethylcellulose, hydroxypropylmethocellulose, or mixtures thereof.

The sweeteners, humectants, modified starches, and gums trap moisture in the filling material 14, which reduces and manages the formation of water crystals when the filled waffle 10 is frozen by forming a viscous mass with the water. Further, the viscous mass prohibits moisture from migrating into the casing material 12.

The salt preferably is chosen from, but is not limited to, sodium chloride, potassium chloride, calcium chloride, and mixtures thereof.

The coloring preferably is chosen from, but is not limited to, natural or artificial coal tar dyes, lake colorants, grape skin extracts, grape concentrate, purple carrot concentrate, fruit juice extracts, fruit juice concentrates, vegetable juice extracts, vegetable juice concentrates, beet, carmine, cochineal extracts, annatto, paprika, turmeric, beta carotene, purple potato, radish, anthocyanins, betaine, caramel, cannine, carotenoids, or mixtures thereof.

The antimyotic preservatives when used are preferably chosen from, but are not limited to, sodium benzoate, potassium sorbate, sodium propionate, calcium propionate, or mixtures thereof.

The humectants preferably are chosen from, but are not limited to, glycerin, sorbitol, fructose, propylene glycol, and mixtures thereof.

The fortificants preferably are chosen from, but are not limited to, ascorbic acid, beta carotene, biotin, calcium pantothenate, choline, folic acid, niacin, Vitamin A, Vitamin B₁, Vitamin B₂, Vitamin B₆, Vitamin B₁₂, Vitamin D₂, niacinamide, Vitamin D₃, Vitamin E, Vitamin K, boron, calcium, chromium, copper, iodine, iron, magnesium, molybdenum, nickel, potassium, selenium, vanadium, zinc, calcium citrate, calcium gluconate, calcium lactate, calcium caseinate, calcium chloride, calcium citrate malate, calcium glycerophosphate, calcium hydroxide, calcium malate, calcium stearate, calcium sulfate, or mixtures thereof.

The protein source preferably is chosen from, but is not limited to, egg albumen, whey protein, soy protein, vital wheat gluten, peanut protein, pea protein, or mixtures thereof.

Shown in Table 2 is a typical batter formulation range that might be used to form the outer casing material 12 of a waffle 10 prepared according to the present invention, all weights are as percent by weight based on the total weight of the casing material 12:

TABLE 2

| Batter Material | Percent by Weight |
|---|---|
| Water | 30-65% |
| Flour | 25-70% |
| Egg | 0-10% |
| Fat | 0-10% |
| Milk Product | 0-4% |
| Sweetener | 0-8% |
| Bicarbonate | 0.05-2.5% |
| Salt | 0-1.5% |
| Leavening Acid | 0.04-2% |
| Fortificants | 0-2.0% |
| Colorant | 0-0.1% |
| Protein | 0-10% |
| Emulsifier | 0-2% |
| Gum | 0-1% |
| Starch | 0-3% |
| Coloring Agents | 0-2% |
| Flavoring Agents | 0-2% |
| Antimycotic Preservatives | 0-1% |

The flour preferably is chosen from, but is not limited to, all-purpose flour, hard wheat flour, soft wheat flour, whole wheat flour, corn flour, oat flour, rice flour, barley flour, or mixtures thereof.

The egg preferably is chosen from, but is not limited to, liquid whole egg, dry whole egg, liquid egg whites, dry egg whites or mixtures thereof.

The fat preferably is chose from, but is not limited to, non-hydrogenated vegetable oil, non-hydrogenated shortening, partially hydrogenated vegetable oil, partially 10 hydrogenated shortening, fully hydrogenated vegetable oil, fully hydrogenated shortening, soybean oil, cottonseed oil, canola oil, peanut oil, safflower oil, sunflower oil, coconut oil, palm oil, palm kernel oil, olive oil, butterfat oil, cocoa butter oil, tallow, lard, corn oil, or mixtures thereof.

The milk product preferably is chosen from, but is not limited to, nonfat dry milk, whole milk solids, casein, hydrolyzed milk protein, milk protein isolate, whole milk, partially defatted milk, skim milk, whey, whey products, or mixtures thereof.

The sweetener preferably is chosen from, but is not limited to, sucrose, dextrose, fructose, lactose, malt syrup, malt syrup solids, rice syrup solids, rice syrup, invert sugar, malt syrup, malt syrup solids, refiners syrup, corn syrup, corn syrup solids, maltose, high fructose corn syrup, honey, molasses, glycerrhizin, arabinose, galactose, glucose, mannitol, maple syrup, ribose, saccharin, xylose, artificial sweeteners, or mixtures thereof.

The sodium bicarbonate preferably is chosen from, but is not limited to, ammonium bicarbonate, potassium bicarbonate, sodium bicarbonate, or mixtures thereof.

The leavening acid preferably is chosen from, but is not limited to, fumaric acid, adipic acid, aceteic acid, tartaric acid, monocalcium phosphate monohydrate, anhydrous monocalcium phosphate, anhydrous dicalcium phosphate, dicalcium phosphate dihydrate, sodium acid pyrophosphate, sodium aluminum phosphate, monoaluminum phosphate, dialuminum phosphate, monoammonium phosphate, diammonium phosphate, sodium aluminum sulfate, or mixtures thereof.

The salt preferably is chosen from, but is not limited to, sodium chloride, potassium chloride, calcium chloride, or mixtures thereof.

The fortificants preferably are chosen from, but are not limited to, ascorbic acid, beta carotene, biotin, calcium pantothenate, choline, folic acid, niacin, Vitamin A, Vitamin B₁, Vitamin B₂, Vitamin B₆, Vitamin B₁₂, Vitamin D₂, niacinamide, Vitamin D₃, Vitamin E, Vitamin K, boron, calcium, chromium, copper, iodine, iron, magnesium, molybdenum, nickel, potassium, selenium, vanadium, zinc, calcium citrate, calcium gluconate, calcium lactate, calcium caseinate, calcium chloride, calcium citrate malate, calcium glycerophosphate, calcium hydroxide, calcium malate, calcium stearate, calcium sulfate, or mixtures thereof.

The colorant preferably is chosen from, but is not limited to, natural color, artificial color, or mixtures thereof.

The protein source preferably is chosen from, but is not limited to, egg albumen, whey protein, soy protein, vital wheat gluten, peanut protein, pea protein, or mixtures thereof.

The emulsifier preferably is chosen from, but is not limited to, mono-glycerides, di-glycerides, propylene glycol monoester, propylene glycol diester, sodium steroyl lactylate, lecithin, polysorbate, sorbitan monostearate, glyceryl lacto ester, or mixtures thereof.

The gum preferably is chosen from, but is not limited to, pectin, guar, locust bean, tara, gellan, alginate, tragacanth, karaya, Ghatti, agar, gelatin, arabic, acacia, carrageenan, xantham, cellulose, carboxymethylcellulose, hydroxypropylmethocellulose, or mixtures thereof.

The starch preferably is chosen from, but is not limited to, natural or modified starches, cornstarch, waxy cornstarch, rice starch, wheat starch, tapioca starch, potato starch, arrowroot starch, maize starch, oat starch, and mixtures thereof.

The batter-coloring agents preferably are chosen from, but are not limited to, natural and artificial coloring agents.

The batter flavoring agents preferably are chosen from, but are not limited to, natural and artificial flavoring agents.

The antimycotic preservatives preferably are chosen from, but are not limited to, sodium benzoate, potassium sorbate, sodium propionate, calcium propionate, or mixtures thereof.

In the formulations listed below, the batter was first mixed to a homogeneous state prior to being poured into a waffle iron. The batter may either be an aerated batter or a non-aerated batter, terms understood by those of ordinary skill in the art. The first layer 25 of batter was poured into the waffle iron and partially cooked prior to depositing of the filling material 14 over the first layer 25. As would be understood by one of ordinary skill in the art, the filling material 14 may be deposited in a single layer, as several layers on top of each other, or as multiple ribbons adjacent to each other. Use of multiple deposits is especially useful when combining several types of fillings such as, for example, a fruit based filling and a cream cheese based filling. Subsequent to depositing the filling material 14, the second layer 26 of batter was poured over the filling material 14 and the waffle iron was closed. The waffle iron was closed for 90 seconds and was set at a temperature of 205° C. Such waffle irons are well known in the art.

The ratio of the uncooked batter to the filling material 14 preferably ranges from 2:1 to 8:1. Optimally, the ratio of the uncooked batter to the filling material 14 is five parts batter to one part of filling material 14. For a five to one ratio, two and one half parts of batter is poured into a lower portion of a waffle iron, one part of the filling material 14 is deposited on top of the batter, and the last two and one half parts of batter poured over, concealing the filling material 14.

The components of the filling material 14 were mixed in a conventional manner as would be understood by one of ordinary skill in the art.

The batter are mixed in a conventional manner. Typically water and flour will be mixed first in a production mixing tank. The other components of the batter are added to the tank as desired. The batter should be mixed at a high speed until a homogeneous batter has been obtained.

### EXAMPLE 1

Fruit filled waffles 10 were prepared, as described above, using the batter shown in Table 3 and the filling shown in Table 4, all weights based on the total weight of the batter or the filling. The components have been used in the ranges shown and suitable products have been formed:

TABLE 3

| Batter Material | Percent by Weight |
|---|---|
| Water | 40-45% |
| Hard Wheat Flour | 35-40% |
| Shortening | 6-15% |
| Liquid Whole Egg | 3-7% |
| Whey | 0.5-3% |
| Granulated Sugar | 1-5% |
| Baking Soda | 0.5-1% |
| Sodium Aluminum Phosphate | 0.4-0.7% |
| Salt | 0.25-1% |
| Monocalcium Phosphate | 0.1-0.5% |

TABLE 4

| Filling Material | Percent by Weight |
|---|---|
| Water | 20-25% |
| Sweeteners | 40-45% |
| Fruit Flakes | 2-10% |
| Instant Modified Starch | 2-5% |
| Citric Acid | 0.2-0.5% |
| Fruit Flavoring | 0.2-0.5% |
| Xanthan Gum | 0.1-0.5% |
| Emulsifier | 0.2-0.5% |
| Powdered Malic Acid | 0.1-0.4% |
| Caramel Coloring | 0.1-0.4% |
| Ground Cinnamon | 0.1-0.5% |
| Salt | 0.1-0.5% |

The resulting filled waffle 10 can be frozen for up to nine months or more and yet retain the fresh-like qualities for the consumer. The packaging necessary for freezer storage includes, but is not limited to sealing the waffle 10 in an airtight wrapper. Sealing the filled waffle 10 in an airtight wrapper will prolong the maximum recommended storage period but is not necessary for short-term storage.

The filled waffle 10 is intended to be heated in an upright toaster until browned and warmed for consumption.

### EXAMPLE 2

Sweet flavor filled waffles 10 were prepared using an alternative filling material 14 wherein the filling is a maple flavored filling presented in Table 5, below. The batter was prepared as described above and the waffles were prepared as described above.

TABLE 5

| Filling Material | Percent by Weight |
|---|---|
| Water | 1-50% |
| Sweeteners | 35-80% |
| Fat | 0-15% |
| Starch | 0.5-5% |
| Xanthan Gum | 0.1-3% |
| Maple Flavoring | 0.01-5% |
| Maple Syrup | 0-20% |
| Acidulant | 0.01-5% |
| Caramel Coloring | 0.01-5% |
| Antimycotic preservative | 0.05-1% |
| Emulsifier | 0-1% |
| Salt | 0.05-2% |

The components are as described above.

### EXAMPLE 3

Cheese filled waffles 10 were prepared using the filling formulation below, the batter described above, and assembled as described above. Examples of useful cheeses include, but are not limited to, cream cheese, imitation cheese, cheese powder, american cheese, asagio cheese, baker's cheese, blue cheese, cheddar cheese, fortina cheese, monterey jack cheese, mozzarella cheese, parmesan cheese, provolone cheese, ricotta cheese, romano cheese, swiss cheese, and mixtures thereof. The dairy cream may include, but is not limited to, whole dairy cream, evaporated dairy cream, powdered dairy cream, dairy analogs, and mixtures thereof.

TABLE 6

| Filling Material | Percent by Weight |
|---|---|
| Sweeteners | 10-50% |
| Cheese | 0.5-30% |
| Egg | 0-10% |
| Fat | 5-30% |
| Emulsifier | 0-1% |
| Xanthan Gum | 0.025-0.20% |
| Dairy Cream | 0-10% |
| Starch | 0.5-5% |
| Antimycotic preservative | 0.05-1% |
| Flavoring | 0.01-5% |
| Salt | 0.05-5% |

The other components are as described above.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A baked and freezer stable filled waffle comprising:
an outer casing material formed from a batter comprising a homogeneous mixture of from 30 to 65 percent by weight water, from 25 to 70 percent by weight of a flour, from 0.05 to 2.5 percent by weight of a bicarbonate and from 0.04 to 2 percent by weight of a leavening acid;
said outer casing material surrounding a filling material having a positive water content of up to 40 percent by weight and said water content in said filling material being less than said percent by weight water in said outer casing material; and
said outer casing material having a water activity level of from 0.9 to 0.99 and said filling material having a water activity level of less than or equal to 0.95 with said water activity level of said filling material being less than said water activity level of said outer casing material.

2. A filled waffle as recited in claim 1, wherein said filling material has a water activity level of from 0.7 to 0.95.

3. A filled waffle as recited in claim 1, wherein said filling material has a water activity level of from 0.80 to 0.90.

4. A filled waffle as recited in claim 1, wherein said filling material comprises at least one of a fruit based filling, a cream cheese based filling, a sweet flavored filling, or mixtures of these.

5. A filled waffle as recited in claim 1, wherein said filling material comprises a savory filling.

6. A filled waffle as recited in claim 5, wherein said filling material comprises at least one of cheese, tomato, tomato and herbs, tomato sauce, vegetables, cheese and vegetable combinations, a cheese, tomato, tomato and herbs, tomato sauce, vegetables, cheese and vegetable combinations, bacon, ham, pork sausage, beef sausage, meat analogs, or mixtures thereof.

7. A filled waffle as recited in claim 1, wherein the ratio of outer casing material to filling material ranges from 2:1 to 8:1.

8. A filled waffle as recited in claim 1, wherein said flour of said outer casing material comprises at least one of all-purpose flour, hard wheat flour, soft wheat flour, whole wheat flour, corn flour, oat flour, rice flour, barley flour, or mixtures thereof.

9. A filled waffle as recited in claim 1, wherein said bicarbonate of said outer casing comprises at least one of ammonium bicarbonate, potassium bicarbonate, sodium bicarbonate, or mixtures thereof.

10. A filled waffle as recited in claim 1, wherein said leavening acid of said outer casing comprises at least one of fumaric acid, adipic acid, aceteic acid, tartaric acid, monocalcium phosphate monohydrate, anhydrous monocalcium phosphate, anhydrous dicalcium phosphate, dicalcium phosphate dihydrate, sodium acid pyrophosphate, sodium aluminum phosphate, monoaluminum phosphate, dialuminum phosphate, monoammonium phosphate, diammonium phosphate, sodium aluminum sulfate, or mixtures thereof.

11. A filled waffle as recited in claim 1, wherein said outer casing material further includes at least one of an egg, a fat, a milk product, a sweetener, a salt, a fortificant, a colorant, a protein, an emulsifier, a gum, a starch, a coloring agent, a flavoring agent, an antimycotic preservative, or mixtures thereof.

12. A filled waffle as recited in claim 11, wherein said egg comprises at least one of liquid whole egg, dry whole egg, liquid egg whites, dry egg whites, or mixtures thereof.

13. A filled waffle as recited in claim 11, wherein said fat comprises at least one of non-hydrogenated vegetable oil, non-hydrogenated shortening, partially hydrogenated vegetable oil, partially hydrogenated shortening, fully hydrogenated vegetable oil, fully hydrogenated shortening, soybean oil, cottonseed oil, canola oil, peanut oil, safflower oil, sunflower oil, coconut oil, palm oil, palm kernel oil, olive oil, butterfat oil, cocoa butter oil, tallow, lard, corn oil, or mixtures thereof.

14. A filled waffle as recited in claim 11, wherein said milk product comprises at least one of nonfat dry milk, whole milk solids, casein, hydrolyzed milk protein, milk protein isolate, whole milk, partially defatted milk, skim milk, whey, whey products, or mixtures thereof.

15. A filled waffle as recited in claim 11, wherein said sweetener comprises at least one of sucrose, dextrose, fructose, lactose, malt syrup, malt syrup solids, rice syrup solids, rice syrup, invert sugar, malt syrup, malt syrup solids, refiners syrup, corn syrup, corn syrup solids, maltose, high fructose corn syrup, honey, molasses, artificial sweeteners or mixtures thereof.

16. A filled waffle as recited in claim 11, wherein said salt comprises at least one of sodium chloride, potassium chloride, calcium chloride, or mixtures thereof.

17. A filled waffle as recited in claim 11, wherein said fortificant comprises at least one of ascorbic acid, beta carotene, biotin, calcium pantothenate, choline, folic acid, niacin, Vitamin A, Vitamin B₁, Vitamin B₂, Vitamin B₆, Vitamin B₁₂, Vitamin D₂, niacinamide, Vitamin D₃, Vitamin E, Vitamin K, boron, calcium, chromium, copper, iodine, iron, magnesium, molybdenum, nickel, potassium, selenium, vanadium, zinc, calcium citrate, calcium gluconate, calcium lactate, calcium caseinate, calcium chloride, calcium citrate malate, calcium glycerophosphate, calcium hydroxide, calcium malate, calcium stearate, calcium sulfate, or mixtures thereof.

18. A filled waffle as recited in claim 11, wherein said protein comprises at least one of egg albumen, whey protein, soy protein, vital wheat gluten, peanut protein, pea protein, or mixtures thereof.

19. A filled waffle as recited in claim 11, wherein said emulsifier comprises at least one of a mono-glyceride, a di-glyceride, a propylene glycol monoester, a propylene glycol diester, a sodium steroyl lactylate, a lecithin, a polysorbate, a sorbitan monostearate, a glyceryl lacto ester, or mixtures thereof.

20. A filled waffle as recited in claim 11, wherein said gum comprises at least one of pectin, guar, locust bean, tara, gellan, alginate, tragacanth, karaya, Ghatti, agar, gelatin, arabic, acacia, carrageenan, xantham, cellulose, carboxymethylcellulose, hydroxypropylmethocellulose, or mixtures thereof.

21. A filled waffle as recited in claim 11, wherein said starch comprises at least one of natural starch, modified starch, cornstarch, waxy cornstarch, rice starch, wheat starch, tapioca starch, potato starch, arrowroot starch, maize starch, oat starch, or mixtures thereof.

22. A filled waffle as recited in claim 11, wherein said preservative comprises at least one of sodium benzoate, potassium sorbate, sodium propionate, calcium propionate or mixtures thereof.

23. A filled waffle as recited in claim 11, wherein said color and said flavor agents comprise at least one of a natural coloring agent, an artificial coloring agent, a natural flavoring agent, an artificial flavoring agent, or mixtures thereof.

24. A filled waffle as recited in claim 1, wherein said outer casing material further comprises from 40 to 45 percent by weight water, from 35 to 40 percent by weight hard wheat flour, from 6 to 15 percent by weight shortening, from 3 to 7 percent by weight liquid whole egg, from 0.5 to 3 percent by weight whey, from 1 to 5 percent by weight sugar, from 0.5 to 1 percent by weight baking soda, from 0.4 to 0.7 percent by weight sodium aluminum phosphate, from 0.25 to 1 percent by weight salt, and from 0.1 to 0.5 percent by weight monocalcium phosphate.

25. A filled waffle as recited in claim 1, wherein said filling material further comprises a first filling material and a second filling material, said second filling material being other than said first filling material;
each of said first filling material and said second filling material having a positive water content of up to 40 percent by weight and said water content in said first and said second filling material being less than said percent by weight water in said outer casing material; and
said outer casing material having a water activity level of from 0.9 to 0.99 and each of said first and said second filling material having a water activity level of less than or equal to 0.95 with said water activity level of said first and said second filling material being less than said water activity level of said outer casing material.

26. A baked freezer stable filled waffle comprising:
an outer casing material formed from a batter comprising a homogeneous mixture of from 30 to 65 percent by weight water, from 25 to 70 percent by weight flour, from 0.05 to 2.5 percent by weight bicarbonate and from 0.04 to 2 percent by weight leavening acid;
said outer casing material surrounding a filling material formed from a mixture comprising a positive water content of up to 40 percent by weight, from 35 to 80 percent by weight sweetners, and from 0.5 to 50 percent by weight fruit source;
said water content in said filling material being less than said percent by weight water in said outer casing material; and
wherein said outer casing material has a water activity level of from 0.9 to 0.99 and said filling material has a water activity level of less than or equal to 0.95 with said water activity level of said filling material being less than said water activity level of said outer casing material.

27. A filled waffle as recited in claim 26, wherein said filling material has a water activity level of from 0.7 to 0.95.

28. A filled waffle as recited in claim 26, wherein said filling material has a water activity level of from 0.80 to 0.90.

29. A filled waffle as recited in claim 26, wherein said flour of said outer casing material comprises at least one of all-purpose flour, hard wheat flour, soft wheat flour, whole wheat flour, corn flour, oat flour, rice flour, barley flour, or mixtures thereof.

30. A filled waffle as recited in claim 26, wherein said bicarbonate of said outer casing comprises at least one of ammonium bicarbonate, potassium bicarbonate, sodium bicarbonate, or mixtures thereof.

31. A filled waffle as recited in claim 26, wherein said leavening acid of said outer casing comprises at least one of fumaric acid, adipic acid, aceteic acid, tartaric acid, monocalcium phosphate monohydrate, anhydrous monocalcium phosphate, anhydrous dicalcium phosphate, dicalcium phosphate dihydrate, sodium acid pyrophosphate, sodium aluminum phosphate, monoaluminum phosphate, dialuminum phosphate, monoammonium phosphate, diammonium phosphate, sodium aluminum sulfate, or mixtures thereof.

32. A filled waffle as recited in claim 26, wherein said outer casing material further includes at least one of an egg, a fat, a milk product, a sweetener, a salt, a fortificant, a coloring agent, a protein, an emulsifier, a gum, a starch, a flavoring agent, an antimycotic preservative, or mixture thereof.

33. A filled waffle as recited in claim 26, wherein said filling material further includes at least one of a starch, a fat, a flavor agent, an emulsifier, an acidulant, a hydrocolloid gum, a salt, a coloring agent, an antimycotic preservative, a humectant, a fortificant, a protein or mixtures thereof.

34. A filled waffle as recited in claim 26, wherein said sweetner of said filling material comprises at least one of sucrose, dextrose, fructose, lactose, malt syrup, malt syrup solids, rice syrup solids, rice syrup, invert sugar, refiners syrup, corn syrup, corn syrup solids, maltose, high fructose corn syrup, honey, molasses, artificial sweeteners, or mixtures thereof.

35. A filled waffle as recited in claim 26, wherein said fruit source of said filling material comprises at least one of fruit flakes, dry fruit flakes, fruit puree, puree concentrate, juice, juice concentrate, fresh fruit, frozen fruit, fruit concentrate, or mixtures thereof.

36. A filled waffle as recited in claim 33, wherein said starch of said filling material comprises at least one of natural starch, modified starch, cornstarch, waxy cornstarch, rice starch, wheat starch, tapioca starch, potato starch, arrowroot starch, maize starch, oat starch, or mixtures thereof.

37. A filled waffle as recited in claim 33, wherein said fat of said filling material comprises at least one of non-hydrogenated vegetable oil, non-hydrogenated shortening, partially hydrogenated vegetable oil, partially hydrogenated shortening, fully hydrogenated vegetable oil, fully hydrogenated shortening, soybean oil, cottonseed oil, canola oil, peanut oil, safflower oil, sunflower oil, coconut oil, palm oil, palm kernel oil, olive oil, butterfat oil, cocoa butter oil, tallow, lard, corn oil, or mixtures thereof.

38. A filled waffle as recited in claim 33, wherein said flavor agent comprises at least one of a natural flavor, an artificial flavor, or mixtures thereof.

39. A filled waffle as recited in claim 33, wherein said emulsifier comprises at least one of a glycerol ester, a diacetyl tartaric acid, an ester of a monoglyceride, a mono-glyceride, a di-glyceride, a polyglycerol ester, a polysorbate, a propylene glycol ester, a rice extract ester, a sodium stearoyl-2-lactylate, a sorbitan ester, a lecithin, a sugar ester, an acetylated monoglyceride, or mixtures thereof.

40. A filled waffle as recited in claim 33, wherein said acidulant comprises at least one of citric acid, malic acid, tartaric acid, lactic acid, acetic acid, phosphoric acid, adipic acid, glucono delta lactone acid, fumaric acid, succinic acid, tarenic acid, or mixtures thereof.

41. A filled waffle as recited in claim 33, wherein said gum comprises at least one of pectin, guar, locust bean, tara, gellan, alginate, tragacanth, karaya, Ghatti, agar, gelatin, arabic, acacia, carrageenan, xanthan, cellulose, carboxymethylcellulose, hydroxypropylmethocellulose, or mixtures thereof.

42. A filled waffle as recited in claim 33, wherein said salt comprises at least one of sodium chloride, potassium chloride, calcium chloride, and mixtures thereof.

43. A filled waffle as recited in claim 33, wherein said coloring agent comprises at least one of natural coloring agent, an artificial coloring agent, or mixtures thereof.

44. A filled waffle as recited in claim 33, wherein said antimycotic preservative comprises at least one of sodium benzoate, potassium sorbate, sodium propionate, calcium propionate or mixtures thereof.

45. A filled waffle as recited in claim 33, wherein said humectant comprises at least one of glycerin, sorbitol, fructose, propylene glycol, or mixtures thereof.

46. A filled waffle as recited in claim 33, wherein said fortificant comprises at least one of ascorbic acid, beta carotene, biotin, calcium pantothenate, choline, folic acid, niacin, Vitamin A, Vitamin B₁, Vitamin B₂, Vitamin B₆, Vitamin B₁₂, Vitamin D₂, niacinamide, Vitamin D₃, Vitamin E, Vitamin K, boron, calcium, chromium, copper, iodine, iron, magnesium, molybdenum, nickel, potassium, selenium, vanadium, zinc, calcium citrate, calcium gluconate, calcium lactate, calcium caseinate, calcium chloride, calcium citrate malate, calcium glycerophosphate, calcium hydroxide, calcium malate, calcium stearate, calcium sulfate, or mixtures thereof.

47. A filled waffle as recited in claim 33, wherein said protein comprises at least one of egg albumen, whey protein, soy protein, vital wheat gluten, peanut protein, pea protein, or mixtures thereof.

48. A filled waffle as recited in claim 26, wherein the ratio of said outer casing material to said filling material ranges from 2:1 to 8:1.

49. A filled waffle as recited in claim 26, wherein said outer casing material further comprises from 40 to 45 percent by weight water, from 35 to 40 percent by weight hard wheat flour, from 6 to 15 percent by weight shortening, from 3 to 7 percent by weight liquid whole egg, from 0.5 to 3 percent by weight whey, from 1 to 5 percent by weight sugar, from 0.5 to 1 percent by weight baking soda, from 0.4 to 0.7 percent by weight sodium aluminum phosphate, from 0.25 to 1 percent by weight salt, and from 0.1 to 0.5 percent by weight monocalcium phosphate.

50. A filled waffle as recited in claim 26, wherein said filling material further comprises 20 to 25% by weight water, 40 to 45% by weight sweeteners, 2 to 10% by weight dry fruit flakes, 2 to 5% by weight instant modified starch, 0.2 to 0.5% by weight citric acid, 0.2 to 0.5% by weight fruit flavoring, 0.1 to 0.5% by weight xanthan gum, 0.2 to 0.5% by weight emulsifier, 0.1 to 0.4% by weight malic acid, 0.1 to 0.4% by weight coloring, 0.1 to 0.5% by weight flavoring other than fruit flavoring, and 0.1 to 0.5% by weight salt.

51. A baked freezer stable filled waffle comprising:
an outer casing material formed from a batter comprising a homogenous mixture of from 30 to 65 percent by weight water, from 25 to 70 percent by weight of a flour, from 0.05 to 2.5 percent by weight of a bicarbonate and from 0.04 to 2 percent by weight of a leavening acid;
said outer casing material surrounding a filling material formed from a mixture of a sweet flavored filling comprising from 1 to 40% by weight water, from 35 to 80% by weight sweetener, from 0.5 to 5% by weight starch, from 0.1 to 3% by weight gum, and from 0.01 to 5% by weight flavoring; and
wherein said outer casing material has a water activity level of from 0.9 to 0.99 and said filling material has a water activity level of less than or equal to 0.95 with said water activity level of said filling material being less than said water activity level of said outer casing material.

52. A filled waffle as recited in claim 51, wherein said filling material has a water activity level of from 0.7 to 0.95.

53. A filled waffle as recited in claim 51, wherein said filling material has a water activity level of from 0.80 to 0.90.
